(19) United States
(12) Patent Application Publication
(10) Pub. No.: US 2023/0015249 A1
(43) Pub. Date: Jan. 19, 2023

(54) MODULAR COMPUTER SYSTEM

(71) Applicant: Framework Computer LLC, Burlingame, CA (US)

(72) Inventors: Nirav Patel, Burlingame, CA (US); Kieran Levin, Burlingame, CA (US); Poyu Chen, Burlingame, CA (US)

(21) Appl. No.: 17/949,061

(22) Filed: Sep. 20, 2022

Related U.S. Application Data
(63) Continuation-in-part of application No. 17/736,765, filed on May 4, 2022.
(60) Provisional application No. 63/246,043, filed on Sep. 20, 2021.
(60) Provisional application No. 63/186,443, filed on May 10, 2021.

(51) Int. Cl. G06F 1/18; G06F 1/16

(52) U.S. Cl. CPC G06F 1/186; G06F 1/1681; G06F 1/1679

(57) ABSTRACT

One variation of a modular computer system includes: a chassis; an expansion slot; and an expansion card. The chassis includes a main board. The expansion slot: is arranged on a lateral side of the chassis; and defines a receptacle inset a bottom side of the chassis. The expansion slot includes: a latching member arranged within the receptacle; and a female connected to the main board. The expansion card includes: an enclosure configured to couple within the receptacle; a latch receiver configured to transiently couple the latching member to maintain the first enclosure within the first receptacle; and a male connector extending from the enclosure, and configured to interface the female connector of the expansion slot. The expansion card further includes an external port arranged at the enclosure and configured to interface with an external device.

### CROSS-REFERENCE TO RELATED APPLICATIONS

This application is a continuation-in-part of U.S. Non-Provisional application Ser. No. 17/736,765, filed on 4 May 2022, which claims the benefit of U.S. Provisional application Ser. No. 63/186,443, filed on 10 May 2021, which is incorporated in its entirety by this reference.

This application claims priority to U.S. Provisional Application No. 63/246,043, filed on 20 Sep. 2021, which is incorporated in its entirety by this reference.

### TECHNICAL FIELD

This invention relates generally to the field of personal computing and more specifically to a new and useful modular computer system in the field of personal computing.

### BRIEF DESCRIPTION OF THE FIGURES

FIG. 1 is a schematic representation of the modular computer system;

FIG. 2 is a schematic representation of the modular computer system;

FIGS. 3A and 3B are a schematic representation of the modular computer system;

FIG. 4 is a schematic representation of the modular computer system;

FIG. 5 is a schematic representation of the modular computer system;

FIG. 6 is a schematic representation of the modular computer system;

FIG. 7 is a schematic representation of the modular computer system;

FIG. 8 is a schematic representation of the modular computer system; and

FIG. 9 is a schematic representation of the modular computer system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

Generally, a modular computer system 100 can include a chassis 110 arranged in a clamshell configuration including a first housing 112 pivotably attached to a second housing 116. The first housing 112 can be arranged to selectively receive a set of computing components within the interior of the first housing 112 including a battery 119, a main board 117, a fan, a processor, a memory component, a storage component, a wireless communications component, a graphics card, a first speaker, and a second speaker. Computing components are selectively attachable to the chassis 110 or to other components by a uniform set of fasteners (e.g., screws).

Furthermore, each component in the set of computing components can selectively insert into a component slot configured to receive the component. For example, a component slot is arranged within the first housing 112 and configured to selectively receive a complementary memory component. The first housing 112 can also include a selectively attachable input cover 159 that is configured to receive a set of user input devices, including a keyboard, a touchpad, a biometric sensor, and an input cable.

The first housing 112 can include an expansion card slot 120 arranged on an exterior edge of the first housing 112 and configured to interface with an expansion card 140 such that, when inserted, the expansion card 140 is flush with the exterior bottom face and exterior side face of the first housing 112. The expansion card slot 120 can include an electrical and data connection to the interior of the chassis and includes an electrical and data connection to the main board 117 of the modular computer system 100.

The second housing 116 can selectively receive a set of computing components arranged within the second housing 116 including: a display 119 arranged within the second housing 116 and connected to a computing component in the first housing 112 and a selectively attachable bezel 160 is arranged about the display 119.

In one variation of the example implementation, the second housing 116 can include a camera connected to a computing component in the first housing 112, a microphone connected to a computing component in the first housing 112, a selectively removable bezel 160 including a camera aperture arranged with the camera and a microphone aperture arranged with the microphone.

### 2. Applications

Generally, existing consumer electronics are designed to be replaced a short time after purchase, due to rapidly evolving components that are produced and assembled in a manner cost-effective for the producer, but not serviceable by a user without the risk of damage to the device. This conventional practice produces detrimental environmental effects by producing more waste per user than if each user purchased a single device, or if the device purchased by a user remained useful for a longer period of time. Further, this waste can include exotic materials that are difficult and expensive to procure as a virgin resource and may be especially toxic when placed in a waste environment. A modular computer system 100 can reduce the detrimental environmental impact of consumer electronics by reducing frequency of replacement of the entire machine. A modular computing system can also reduce long-term ownership cost of the system by enabling a user to replace broken components, upgrade to the newest components, and add new components to increase the functionality or capability of the modular computing system.

Generally, a modular computer system 100 can include a laptop chassis 110 or frame and component parts as selected by the user, including a keyboard, a trackpad, a set of wired external communications ports, a set of wireless communications modems and processors, a battery 118, a display 119, processors (e.g., core and peripheral microprocessors), memory, storage, speakers, camera(s), etc. The modular computer system 100 can be customizable, repairable, and upgradable by the user through replacement of existing modular computer components and the purchase of new modular computer components for their modular computer system 100. Each component includes information printed on the device that informs what the component is, and either instructions regarding how to service it, or a code to another document, such as a webpage, where long-form instructions or video instructions are located.

The modular computer system 100 includes a chassis 110 configured to open with no tools (e.g., via manually operable latches) or with basic tools (e.g., a screwdriver), thereby enabling a user to simply access the interior of the modular computer system 100 chassis 110 and replace select components. The layout of interior components within the chassis 110 is optimized in a configuration to allow a user to see, inspect, and remove individual components with minimal impact to adjacent components (i.e., a first component is not required to be moved in order to access a second component). Components are selectively attachable with a uniform set of repeatable fasteners, as opposed to one-time fasteners that could break or become unusable if a user attempted to remove a component.

### 2.1 Examples

For example, if a user perceives reduced memory performance or verifies a need for additional memory capacity via a system check of the modular computer system 100, the user may: open the chassis no of the modular computer system 100 using basic tools; identify the memory component by the component label; read an identifying code printed on the component; and search for a replacement part. Alternatively, the user may: open a camera application on their smartphone; sweep their smartphone across the interior of their modular computer system 100; the camera application may then read a QR code located on the memory component, and then automatically open a page in a web browser; and, from this page, the user may review the instructions to remove the memory, order a replacement memory component, or order an upgraded memory component with improved attributes. Later, the user will receive the ordered replacement component. The user may then remove the damaged or insufficient memory component from the chassis 110 using basic tools and insert the new replacement or upgraded component. The user may then close the chassis 110 of the modular computer system 100 using basic tools, power the system on, and use the system.

In another example, the user can change the functionality of the modular computer system 100 without disassembly. The modular computer system 100 is received by a user with an expansion card 140 supporting USB-C™ inserted into the expansion slot 120. A user may acquire additional expansion cards 140 which support other connection types such as USB-A™, HDMI™, or Display Port™. The user may remove the first expansion card 140 and insert a second expansion card with another connection type to change the input function of the modular computer system 100. When the expansion card 140 is changed, the modular computer system 100 recognizes the connection type supported by the inserted expansion card 140, and routs data or power accordingly.

### 3. Chassis

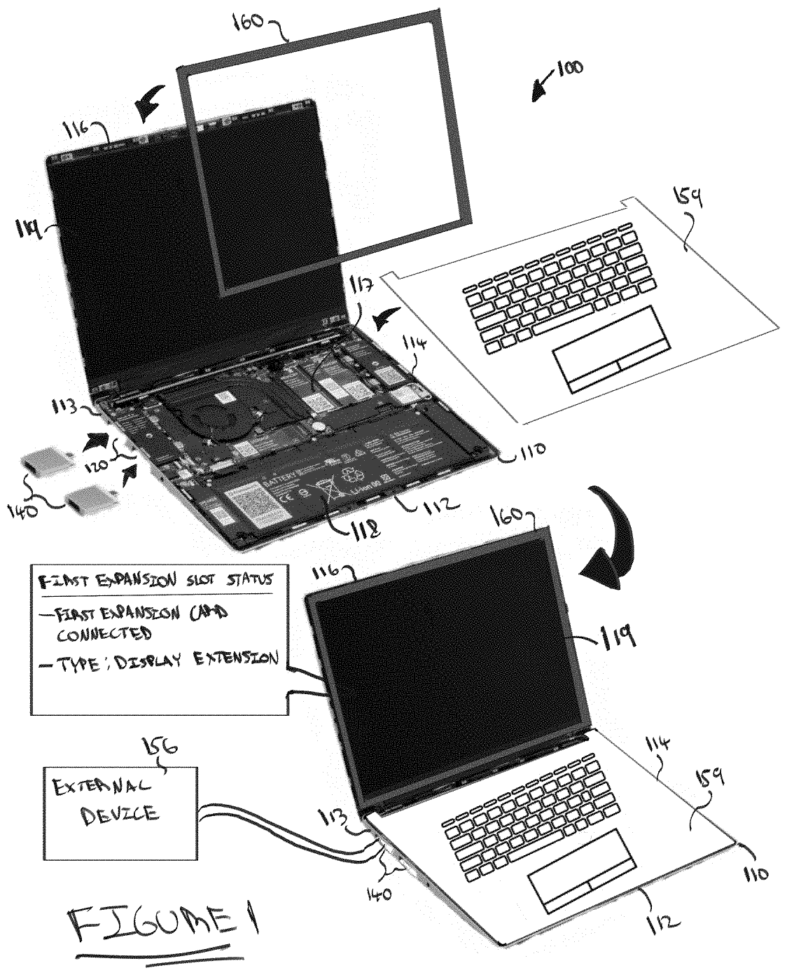

As shown in FIG. 1, the chassis no can be arranged in a clamshell configuration including a first housing 112 pivotably connected to a second housing 116. The chassis 110 houses components in a layout optimized for serviceability that allows a user to view and/or access a set of components at a single time. The component layout minimizes the need to remove a first component to access a second component within the chassis 110. For example, as shown in FIG. 1, the battery 118 is arranged adjacent to the main board 117. The battery 118 and the main board 117 can each be selectively removed from the first housing 112 without removing the other component.

In one variation of the example implementation a label is included on each of the individual components within the set of components. The label can include information, instructions, a QR code, or another suitable code format. The label may be printed, stamped, embossed, or otherwise durably marked on the surface of the component. In one variation, the label can contain a link to a webpage containing instructions to remove, install, service, sell, or to order a new part.

In another variation of the example implementation, individual components of the set of computing components are connected to one another via cables within the chassis no. The chassis 110 includes a set of cable pathways arranged such that, during repair or maintenance, the placement or removal of a cable within the chassis no does not affect other cables, components, or structures within the chassis no. The cables can run between components within the chassis no to connect components together electrically. For example, the battery 118 is arranged within the chassis no between the speaker and the speaker connector disposed on the main board 117. A cable pathway extends from the connector on the main board 117, between the battery 118 and the main board 117, to the speaker. The cable pathway can include a set of structures or retaining features that: hold the cable in place during normal operation; and prevent movement of the cable during repair or replacement of computer components, such as when the battery 118 is removed from the chassis 110.

In another variation of the example implementation, the modular computer system 100 includes a uniform set of fasteners (e.g., threaded screws) that function to transiently secure a first component to the chassis 110 or to a second component. For example, the battery 118, main board 117, and input cover 159 are all secured to the chassis 110 with a set of screws that share the same size and pattern of driver interface, therefore only a single screwdriver with matching driver pattern is needed to remove all three components from the chassis no. In a variation of the example implementation, the uniform set of fasteners can include a set of latches, pins, or braces that can transiently secure components to the chassis no without requiring tools.

In this variation, a component can include a connector that defines an element of the component that interfaces with cable connections or with a component slot to create an electrical and/or data connection. In another variation of the example implementation, sensitive or delicate connectors of components are configured to minimize damage to components or component slots when installing or removing components. For example, the connector can be configured to be asymmetrical and/or define a unique geometry to prevent incorrect orientation and incorrect insertion of the connector into the complementary component slot.

In another variation of the example implementation, a fastener secures a component to the chassis no at a first end of the component, and a second end of the component opposite the first end includes a connector. The connector is insertable into a component slot. The component slot is pivotably attached to the chassis 110 and is spring-loaded to lever the connected component out of the chassis 110 when the fastener is removed.

In another alternative variation of the example implementation, a set of components can include magnets to align features of components and facilitate correct installation without damage to components. To prevent damage or magnetic interference, the alignment magnet can be placed a distance away from any magnetically-sensitive component. The distance is determined by the magnetic force of the alignment magnet, and the distance between the magnet and any magnetically-sensitive component. Magnetic shielding can also be used around the magnet or the magnetically sensitive component to prevent damage or electromagnetic interference. For example, the input cover 159 can include an alignment magnet arranged on the outer edge of the first housing 112 to align the input cover 159 when the input cover 159 is selectively attached to the first housing 112 by a user.

In another variation of the example implementation, the chassis 110 can include a first housing 112 and a second housing 116 selectively paired with the first housing 112 via a hinge mechanism. A single selectively attachable electrical connection that carries power and data between the first housing 112 and the second housing 116 is arranged proximal to the selectively attachable hinge mechanism. The selectively attachable cable connection is arranged proximal to the selectively attachable hinge mechanism.

### 4. First Housing

Generally, the first housing 112 is a unibody construction formed from aluminum. The first housing 112 is pivotably attached to a second housing 116 to create a notebook configuration. In one variation of the example implementation, the first housing 112 is composed of another material such as plastic, polymer, or another metal. In another variation of the example implementation, the first housing 112 can be formed from two or more modules which are assembled to form the first housing 112.

As shown in the FIG. 1, the first housing 112 can arrange a set of computing components including a battery 118, a main board 117, a fan, a processor, a memory component, a storage component, a wireless communication card, a graphics card, and a speaker. Furthermore, the first housing 112 can receive an input cover 159 selectively attachable to the first housing 112.

### 4.1 Battery

As shown in FIG. 1, the battery 118 can be selectively attachable to the first housing 112 via a uniform set of fasteners and electrically connected to the main board 117 and/or other components within the modular computer system 100. The battery 118 generally supplies power for the modular computer system 100 when the modular computer system 100 is not otherwise powered.

### 4.2 Main Board

As shown in FIG. 1, the main board 117 can include essential components necessary to provide basic computing function and support for the processor, including the memory component, the storage component, and the fan. The main board 117 also includes an input cable connection port. The main board 117 can be selectively attached to the first housing 112 as a single component while other components are physically and electrically attached to the main board 117. In one variation of the example implementation, components can be selectively attached to the main board 117 while the main board 117 remains physically or electrically attached to the first housing 112. The fan is selectively attached to the main board 117 using a uniform set of fasteners, is electrically connected to the main board 117, and is located proximal to the processors to control the airflow proximal to the processors. The memory component is selectively attached to the main board 117 using a uniform set of fasteners and is electrically connected to the main board 117. The storage component is selectively attached to the main board 117 using a uniform set of fasteners and is electrically connected to the main board 117.

### 4.3. Other Components

The modular computer system 100 can also include a set of other computer components. For example, a wireless communication component can be selectively attachable to the first housing 112 using a uniform set of fasteners and can be electrically connected to the main board 117. Additionally, a graphics card can be selectively attachable to the first housing 112 using a uniform set of fasteners and can be electrically connected to the main board 117. Additionally, a speaker can be selectively attached to the first housing 112 using a uniform set of fasteners and can be electrically connected to the main board 117.

### 4.4 Uniform Fasteners and Tooling

Generally, computing system components are selectively connected to the first housing 112 by a uniform set of fasteners, such as screws. In the example implementation, screws used in construction of the modular computer system 100 can have different attributes such as width, length, pitch, or material, but screws can have the same size and pattern of driver interface, therefore only a single screwdriver with matching driver pattern is needed to manipulate screws.

In the example implementation, a computing system component is selectively insertable into a component slot arranged within the first housing 112. In one variation of the example implementation, the component slot is configured to secure the component within the chassis 110 using a friction fit. In another variation of the example implementation, a component slot is unique to the type of component it receives in order to prevent an incorrect component connection and to safeguard against damage to the component or the modular computer system 100. For example, the first component slot that selectively receives the memory component, is configured to have a different shape than the second component slot that selectively receives the storage component.

### 4.5 Input Cover

As shown in FIG. 1, in one variation of the example implementation, the input cover 159 can be selectively attachable to the first housing 112. When attached, the combination of the input cover 159 and the first housing 112 encloses the components contained within the first housing 112. In the example implementation, the input cover 159 contains a set of user input devices. For example, the set of user input devices can include a keyboard, a touchpad, and/or a biometric sensor. In one variation of the example implementation, the biometric sensor can include a fingerprint sensor.

In this variation of the example implementation, the input cover 159 can be selectively attachable to the face of the first housing 112 proximal to the display 119 and opposite the expansion slot 120. In one variation of the example implementation, the input cover 159 is configured with magnets to align the input cover 159 with the receiving features of the first housing 112. For example, the input cover 159 includes an input cover 159 alignment magnet, which interfaces with a first housing 112 alignment magnet to align the input cover 159 with the first housing 112.

In one variation of the example implementation, the user input components are selectively attachable to the input cover 159. For example, a keyboard, a touchpad, and/or a biometric sensor, are each selectively attachable to the input cover 159 using a uniform set of fasteners or mechanical latches and are electrically connected to the input cable.

The input cable can be connected to the face of the input cover 159 opposite the functional interfaces of the keyboard, touchpad, and biometric sensor. The input cable is configured to extend from its connection point on the input cover 159, to the input cable connection port, located on the main board 117 within the first housing 112, when the input cover 159 is removed and placed in-plane with and adjacent to the first housing 112. Further, the input cable is configured to fold in a designated, repeatable pattern within the first housing 112 when the input cover 159 is attached and connected to the first housing 112. The input cable folds to prevent damage to the input cable and other components disposed within the first housing 112. For example, when the input cover 159 is removed from the first housing 112 and placed adjacent to the first housing 112 by a user, the input cable remains connected to both the connection point on the input cover 159 and the input cable receiving port on the main board 117. During removal, the input cable does not interfere with the motion of the input cover 159, elements of the modular computer system 100 are not stressed to the point of failure.

In one variation of the example implementation, the input cover 159 is connected to a disconnect switch that can be paired with a disconnect switch receiver and that is configured to alert a user if the input cover 159 is improperly arranged or open. In operation, the disconnect switch interfaces with a disconnect switch receiver when the input cover 159 is properly attached to the first housing 112. Conversely, if the disconnect switch receiver detects separation of the input cover 159 from the first housing 112, the disconnect switch receiver generates a warning signal (e.g., audio and/or visual signal) to indicate that the input cover 159 is open and the modular computer system wo is powered on.

In another variation of the example implementation, the keyboard is selectively removable from the input cover 159 and can be replaced with an alternate component. The alternate component can be a different component or an upgraded component such as an illuminated keyboard, a keyboard in another language, a keyboard with a mechanical action, a keyboard with an optical action, a keyboard with a different depth of keystroke, etcetera.

### 5. Second Housing

As shown in the FIG. 1, the second housing 116 is a unibody construction formed from aluminum. The second housing 116 is pivotably attached to a first housing 112 to create a notebook configuration. The second housing 116 can include a selectively removable display 119. A fastener can secure the display 119 to the second housing 116, and a cable can connect to the graphics card located in first housing 112. The second housing 116 can also include a selectively removable bezel 160 arranged about the display 119. The bezel 160 covers the cables connected to the components within the second housing 116 and support structures that hold the components in place within the second housing 116 to protect the components and connections. The bezel 160 can be formed from aluminum.

In one variation of the example implementation, the second housing 116 is composed of another material such as plastic, polymer, or another metal. In another variation of the example implementation, the second housing 116 can be formed from two or more modules that are assembled to form the second housing 116.

In another variation of the example implementation, the bezel 160 can be composed of plastic, polymer, glass, or a composite material. In another variation of the example implementation, the bezel 160 can be transparent, protecting the components within the second housing 116, but allowing viewing of the components with the bezel 160 in place.

In another variation of the example implementation, the second housing 116 can include a camera and a microphone. A fastener can secure the camera to the second housing 116 and the camera can be electrically connected to a component in the first housing 112. A fastener can secure the microphone to the second housing 116 and the microphone can be electrically connected to a component in the first housing 112. A camera aperture can be disposed proximal to the camera in the bezel 160 and a microphone aperture can be disposed proximal to the microphone in the bezel 160.

In another variation of the example implementation, a fastener attaches a camera switch to the second housing 116. The camera switch is electrically connected between the camera and main board 117. When the camera switch is engaged, the camera is connected to the main board 117 and electrical signals pass between the camera and the main board 117. When the camera switch is disengaged, the camera is disconnected from the main board 117 and electrical signals do not pass between the camera and the main board 117. The camera switch enables complete physical disconnection of the camera from the main board 117 so that the camera cannot be powered and accessed remotely, and thereby provides user privacy while the user operates the modular computer system 100. In a further variation of the example implementation, the camera switch is an optical switch electrically connected between the camera and the main board 117.

In another variation of the example implementation, a fastener attaches a microphone switch to the second housing 116. The microphone switch is electrically connected between the microphone and the main board 117. When the microphone switch is engaged, the microphone is connected to the main board 117 and electrical signals pass between the microphone and the main board 117. When the microphone switch is disengaged, the microphone is disconnected from the main board 117 and electrical signals do not pass between the microphone and the main board 117. The microphone switch enables complete physical disconnection of the microphone from the main board 117 so that the microphone cannot be powered and accessed remotely, and thereby provides user privacy while operating the modular computer system 100. In a further variation of the example implementation, the microphone switch is an optical switch electrically connected between the microphone and the main board 117.

### 6. Expansion Card System

As shown in FIGS. 1, 2, and 3, a modular computer system 100 includes: a chassis 110; a first expansion slot 120; and a first expansion card 140.

The chassis 110 includes: a first housing 112 including a main board 117; and a second housing 116 pivotably coupled to the first housing 112, and including a display 119 connected to the main board 117.

The first expansion slot 120: is arranged on a first lateral side 113 of the first housing 112; and defines a first receptacle 121 inset a bottom side 115 of the first housing 112. The first expansion slot 120 includes: a first latching member 125 arranged within the first receptacle 121; and a first female connector 126 arranged along a first interior sidewall 122 of the first receptacle 121 and connected to the main board 117.

The first expansion card 140 includes: a first enclosure 141 configured to couple within the first receptacle 121; a first latch receiver 148 arranged on the first enclosure 141, and configured to transiently couple the first latching member 125 within the first receptacle 121 to maintain the first enclosure 141 within the first receptacle 121; and a first male connector 150 extending from a first sidewall 142 of the first enclosure 141, and configured to interface the first female connector 126 within the first receptacle 121 of the first expansion slot 120. The first expansion card 140 further includes a first external port 151 arranged at a second sidewall 143 of the enclosure 141, opposite the first sidewall 142, and configured to interface with a first external device 156.

### 7. Applications

Generally, the modular computer system 100 can include multiple expansion cards 140 transiently mountable within expansion slots 120 arranged at the chassis 110 in order to modify peripheral inputs at the modular computer system 100. Generally, the expansion slot 120 can include: a latching member 125; and a female connector 126. Additionally, the expansion card 140 can include: an enclosure 141; a latch receiver 148 configured to couple the latching member 125; and a male connector 150 configured to couple the female connector 126 of the expansion slot 120. The female connector 126 within the expansion slot 120 is connected to the main board 117 within the chassis 110. Thus, when the male connector 150 of the expansion card 140 couples the female connector 126 within the expansion slot 120, the expansion card 140 is communicably coupled to the main board 117 of the modular computer system 100. The modular computer system 100 can then route signals (e.g., data signals, power signals) to and from the expansion card 140 coupled within the expansion slot 120. The expansion cards 140 can be implemented to expand peripheral inputs of the modular computer system 100, such as by adding an external display port, an external memory port, and external power input.

In one example, the modular computer system 100 includes an expansion slot 120 including an external port 151 (e.g., display port, memory port) arranged at the enclosure 141. In this example, the male connector 150 is arranged at a first sidewall 142 of the enclosure 141 and connected to an internal PCB within the enclosure 141. Additionally, the external port 151 is: arranged at a second sidewall 143, opposite the first sidewall 142, of the enclosure 141; and connected to the internal PCB within the enclosure 141. Thus, the external port 151 can receive an input signal (e.g., power signal, data signal), and output this signal at the male connecter of the expansion card 140. The expansion card 140 can then be selectively mounted to an expansion slot 120 at the chassis 110 to communicably couple the expansion card 140 to the main board 117 and therefore integrate an additional external port 151 for the modular computer system 100.

In another example, the modular computer system 100 includes an expansion card 140 including a storage module 153 (e.g., flash storage component) arranged within the enclosure 141. In this example, the storage module 153 is connected to an internal PCB of the enclosure 141. The male connector 150 is arranged at the first sidewall 142 of the enclosure 141 and connected to the internal PCB. Thus, when the male connector 150 couples the female connector 126 within the expansion slot 120, the storage module 153 is communicably connected to the main board 117 within the chassis 110 thereby expanding memory storage for the modular computer system 100.

Therefore, the modular computer system 100 can include a set of expansion cards 140, each selectively mounted to expansion slots 120 at the chassis no, and thereby expand peripheral inputs, memory storage, and power storage of the modular computer system 100.

### 8. Expansion Slot

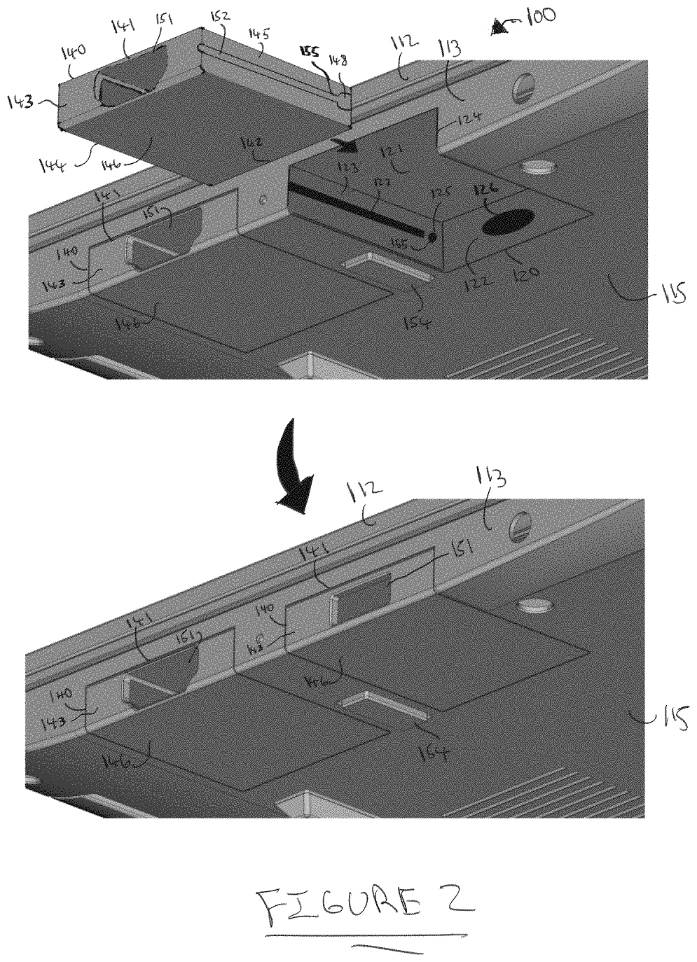

In one implementation as shown in FIGS. 1 and 2, the modular computer system 100 includes an expansion slot 120: arranged on a first lateral side 113 of the first housing 112; and defining a receptacle 121 inset a bottom side 115 of the first housing 112. In this implementation, the first housing 112 includes: a top side pivotably coupled to second housing 116 of the chassis no; a bottom side 115 opposite the top side; the first lateral side 113 normal the top side and the bottom side 115 of the first housing 112; and a second lateral side 114, opposite the first lateral side 113, and normal the top side and the bottom side 115 of the first housing 112. Additionally, the receptacle 121 is configured to receive the expansion card 140 and defines: a first open face at the bottom side 115 of the first housing 112; and a second open face at the first lateral side 113 of the first housing 112.

In the foregoing implementation, the expansion slot 120 includes a latching member 125 (e.g., a hook, a magnetic element) and a female connector 126 (e.g., a female port interface). The latching member 125: is arranged within the receptacle 121 (e.g., protruding from an interior sidewall); and configured to couple the expansion card 140 within the receptacle 121. Additionally, the female connector 126: is arranged along a first interior sidewall 122 of the receptacle 121: and connected to the main board 117, such as via a ribbon cable or directly connected to the main board 117. The modular computer system 100 can thus route electrical signals (e.g., data signals, power signals) from the main board 117 to the expansion card 140 mounted at the expansion slot 120.

In one example, the receptacle 121 can define: the first interior sidewall 122 facing the main board 117 within the first housing 112 of the chassis 110; a third interior sidewall 123 normal the first interior sidewall 122 of the receptacle 121; and a fourth interior sidewall 124, opposite the third interior sidewall 123, and normal the first interior sidewall 122 of the receptacle 121. In this example, each of the first interior sidewall 122, the third interior sidewall 123, and the fourth interior sidewall 124 envelop the expansion card 140 when inserted into the expansion slot 120. Furthermore, the latching member 125: can be arranged at the third interior sidewall 123 and/or the fourth interior sidewall 124 of the receptacle 121: and is configured to couple the expansion card 140 thereby supporting the expansion card 140 within the expansion slot 120.

In one implementation as shown in FIGS. 1 and 2, the modular computer system 100 can include a second expansion slot: arranged on the first lateral side 113 of the first housing 112; adjacent the first expansion slot 120; and defining a second receptacle 121 inset the bottom side 115 of the first housing 112. In this implementation, the second expansion slot includes: a second latching member arranged within the second receptacle 121; and a second female connector 126 arranged along an interior sidewall of the second receptacle 121 and connected to the main board 117. In this implementation, the second expansion slot is congruent the first expansion slot 120 thereby allowing for a singular expansion card 140 to be selectively mounted to the each of the first expansion slot 120 or the second expansion slot. In one variation of this implementation, the modular computer system 100 can include the second expansion slot arranged on a second lateral side 114, opposite the first lateral side 113, of the first housing 112.

Therefore, the modular computer system 100 can include multiple expansion slots 120 arranged laterally about the chassis 110, each expansion slot 120 interfacing with the main board 117 within the chassis 110, and thereby enabling a user to selectively mount a singular expansion card 140 to a particular location at the chassis 110 of the modular computer system 100.

### 9. Expansion Cards

Generally, the modular computer system 100 includes an expansion card 140 selectively attachable to the first housing 112 via the expansion slot 120 thereby allowing a user to selectively configure external components, such as external port connections and external memory storage at the modular computer system 100.

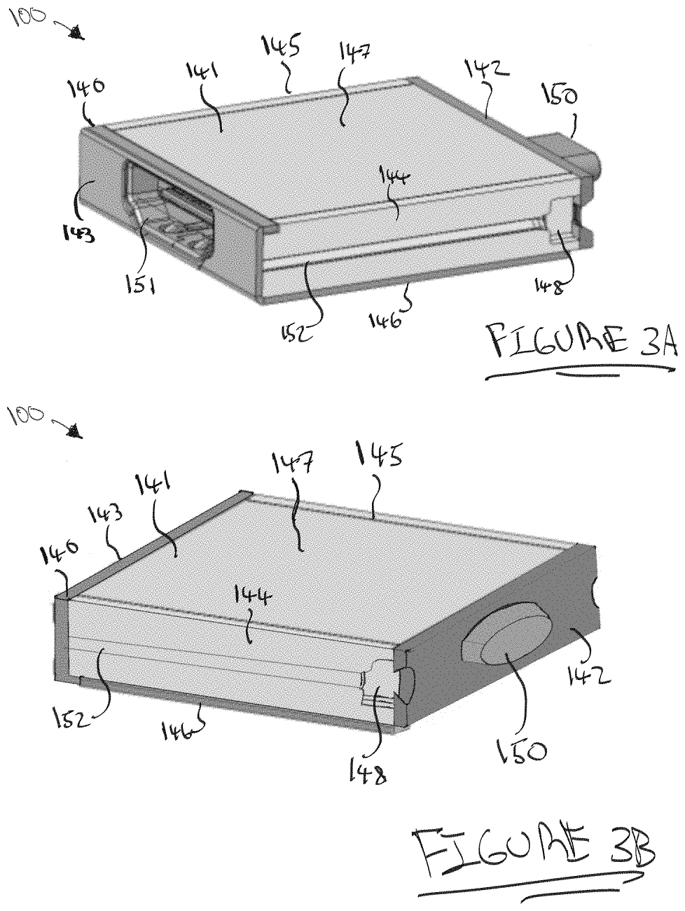

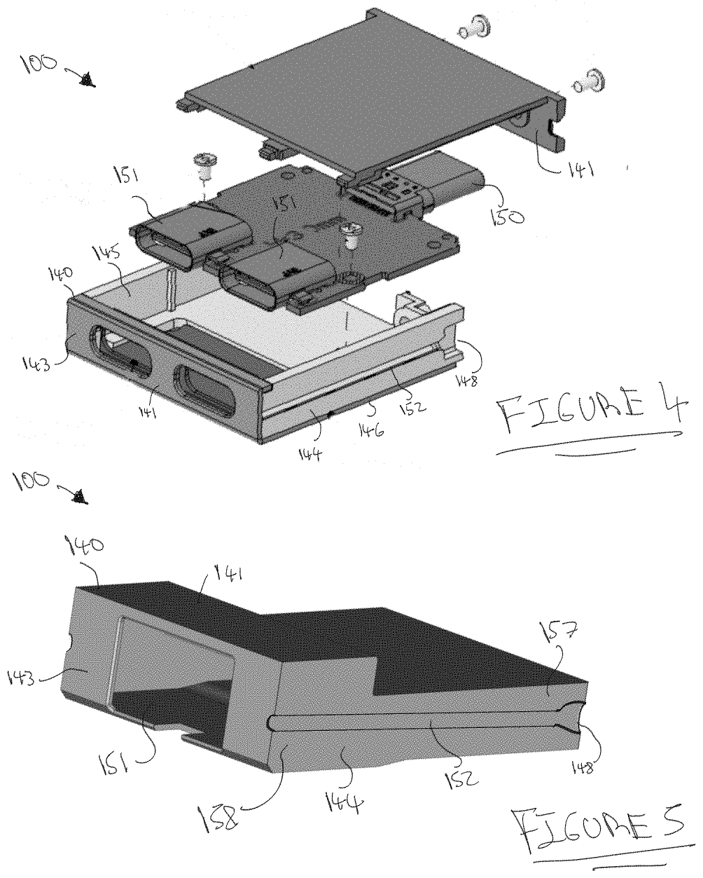

In one implementation as shown in FIGS. 3A and 3B, the modular computer system 100 includes an expansion card 140 including: an enclosure 141 (e.g., a rectangular enclosure 141); a latch receiver 148 (e.g., magnetic element, cavity); a male connector 150 (e.g., a data transfer connector); and an external port 151 (e.g., a data transfer port, memory storage port, power connecter port). The enclosure 141: can include a PCB (printed circuit board) arranged within an interior of the expansion card 140; and is configured to couple within the receptacle 121 of the expansion slot 120. In this implementation, the latch receiver 148 is arranged at a sidewall of the enclosure 141 and configured to couple the latching member 125 within the receptacle 121 of the expansion slot 120, thereby maintaining the enclosure 141 within the receptacle 121. The male connector 15o: is connected to the PCB within the interior of the enclosure 141; and extends outwardly from the enclosure 141 to interface the female connector 126 within the receptacle 121 of the expansion slot 120. In particular, the male connector 150 can include a male-type data transfer connector, such as a USB™ type-C male connector 150, a USB™ type-B male connector 150, a Thunderbolt™ connector, etc. The female connector 126 can include a female-type data transfer connector such as a USB™ type-C female port, a USB™ t e-B female port, a Thunderbolt™ female port, etc. Thus, the female connector 126 interfaces the main board 117 within the chassis 110 to route electrical signals (e.g., data signals, power signals) received at the male connector 150 of the expansion card 140 to the main board 117, thereby communicably coupling the expansion card 140 to the main board 117 of the modular computer system 100.

In the aforementioned implementation, the external port 151: is arranged at the enclosure 141 opposite the male connector 150; connected to the PCB arranged within the enclosure 141; and configured to interface with an external device 156 (e.g., a battery 118 charger, a display 119 cable, a memory card, headphones, microphones). Thus, the modular computer system 100 can receive an input signal (e.g., data signal, power signal) from the external device 156, and can route this input signal to the main board 117 within the chassis no of the modular computer system 100.

In one example, the enclosure 141 can define a rectangular geometry cooperating with the receptacle 121 of the expansion slot 120 and including: a first sidewall 142; a second sidewall 143 arranged opposite the first sidewall 142; a third sidewall 144 arranged normal the first sidewall 142 and the second sidewall 143; and a fourth sidewall 145 arranged opposite the third sidewall 144, and normal the first sidewall 142 and the second sidewall 143. Additionally, the enclosure 141 can include a top cover 147 arranged above the first sidewall 142, the second sidewall 143, the third sidewall 144 and the fourth sidewall 145. The enclosure 141 further includes a bottom cover 146 arranged below the first sidewall 142, the second sidewall 143, the third sidewall 144 and the fourth sidewall 145.

In the aforementioned example, the male connector 150 is arranged at the first sidewall 142 of the enclosure 141. Additionally, the external port 151 is arranged at the second sidewall 143, opposite the first sidewall 142, of the enclosure 141. Thus, when the expansion card 140 is inserted at the expansion slot 120, the male connector 150 of the enclosure 141 couples the female connector 126 within the expansion slot 120 and the external port 151 remains exposed at the lateral side of the first housing 112 to receive the external device 156. Furthermore, the latch receiver 148: is arranged at the third sidewall 144 of the enclosure 141; and defines a cavity inset the third sidewall 144 configured to receive the latching member 125 arranged at the third interior sidewall 123 of the receptacle 121 of the expansion slot 120.

In one implementation, the modular computer system 100 can include an additional expansion card 140 mountable at the expansion slot 120 and/or at a second expansion slot at the first housing 112 of the chassis 110. In particular this additional expansion card 140 can include: a second enclosure 141 configured to couple within the second housing 116; a second latch receiver 148 arranged on the second enclosure 141, and configured to couple the latching member 125 within the receptacle 121 to maintain the second enclosure 141 within the receptacle 121; and a second male connector 150 extending from the second enclosure 141, and configured to interface the female connector 126 within the receptacle 121 of the expansion slot 120.

Therefore, the modular computer system 100 can include a set of expansion cards 140, each expansion card 140 in the set of expansion cards 140, including different types external ports 151, thereby allowing a user to selectively mount a peripheral interface at particular locations at the chassis 110 of the modular computer system 100.

In one implementation as shown in FIG. 2, the modular computer system 100 includes an expansion card 140 insertable within the expansion slot 120 of the first housing 112, such that the expansion card 140 is set flush with the lateral side and the bottom side 115 of the first housing 112. For example, when the expansion card 140 is nested within the expansion slot 120, the male connector 150 at the first sidewall 142 of the enclosure 141 couples the female connector 126 at the first interior sidewall 122 of the receptacle 121, thereby setting the first sidewall 142 of the enclosure 141 abutting the first interior sidewall 122 of the receptacle 121. In this example, the first sidewall 142 of the enclosure 141 defines a thickness cooperating with a thickness of the first interior sidewall 122 of the receptacle 121, and thereby sets the bottom cover 146 of the enclosure 141 flush with the bottom side 115 of the first housing 112. Additionally, when the expansion card 140 is nested within the expansion slot 120, the third sidewall 144 of the enclosure 141 is set abutting the third interior sidewall 123 of the receptacle 121, and the fourth sidewall 145, opposite the third sidewall 144, of the enclosure 141 is set abutting the fourth interior sidewall 124 of the receptacle 121. In this example, the third sidewall 144 and the fourth sidewall 145 each define a particular length cooperating with a particular length of the third interior sidewall 123 and the fourth interior sidewall 124 of the receptacle 121 thereby setting the second sidewall 143, opposite the first sidewall 142, of the enclosure 141 flush with the lateral side of the first housing 112.

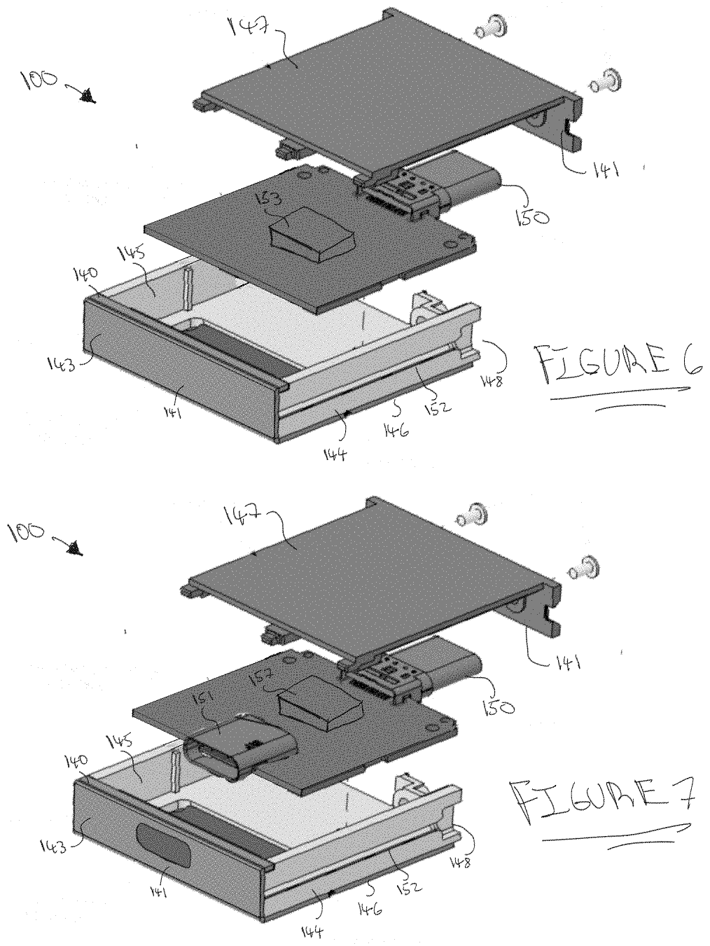

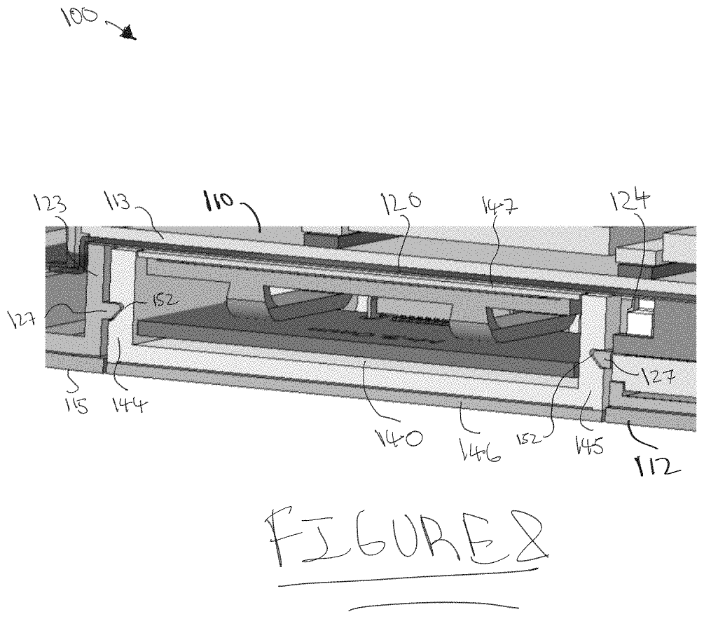

In another implementation as shown in FIG. 5, the modular computer system 100 includes an expansion card 140 insertable within the expansion slot 120 of the first housing 112, such that the expansion card 140 extends outwardly from the lateral side of the first housing 112 in order to accommodate external ports 151 protruding from the first housing 112. In this implementation, the expansion card 140 can include: a first portion 157 arranged within the receptacle 121; and a second portion 158 extending from the first portion 157. The first portion 157 includes: the first sidewall 142 of the enclosure 141 of a first thickness within the receptacle 121; and the first male connector 150 extending from the first sidewall 142. The second portion 158 is arranged proximal the lateral edge of the first housing 112 and includes: the second sidewall 143, opposite the first sidewall 142, of a second thickness greater than the first thickness; and the external port 151 arranged within the second portion 158 of the enclosure 141. Therefore, the expansion card 140 can accommodate external ports 151, such as an Ethernet™ port, a Midi™ port which can include a thickness greater than a thickness of the receptacle 121 of the expansion slot 120.

### 9.1 Expansion Card Retention

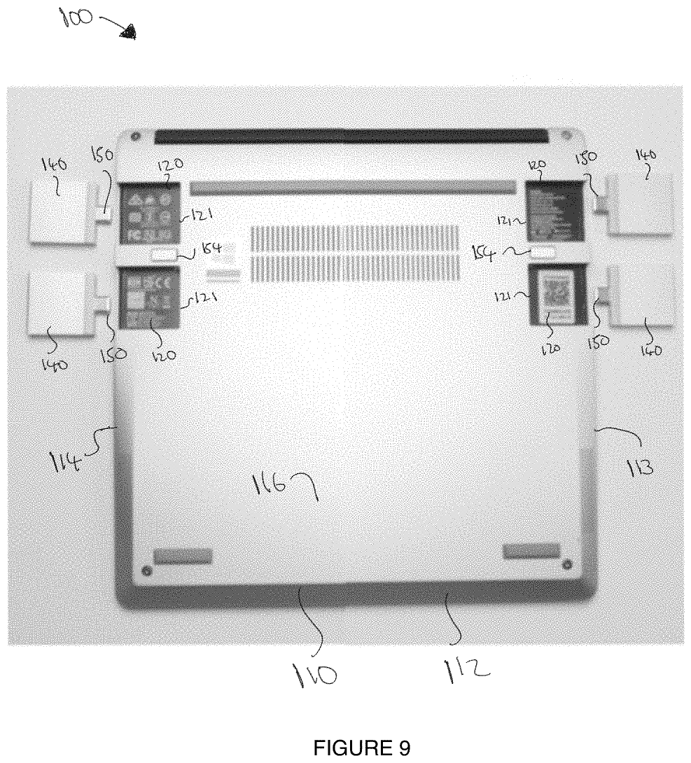

In one implementation as shown in FIGS. 2 and 9, the modular computer system 100 can include an expansion slot 120 including a guide rail 127: arranged within the receptacle 121 of the expansion slot 120; and configured to support the expansion card 140 within the receptacle 121 of the expansion slot 120. In this implementation, the modular computer system 100 can include an expansion card 140 including a channel 152: arranged at a sidewall of the enclosure 141; and configured to receive the guide rail 127 at the expansion slot 120 to maintain the expansion card 140 within the receptacle 121.

For example, the expansion slot 120 can include a first guide rail 127 arranged at (e.g., protruding linearly across) the third interior sidewall 123 of the receptacle 121. Additionally, the expansion slot 120 can include a second guide rail arranged at (e.g., protruding linearly across) the fourth interior sidewall 124, opposite the third interior sidewall 123, of the receptacle 121. Additionally, in this example, the expansion card 140 includes: a first channel 152 inset along the third sidewall 144 of the first enclosure 141, and configured to receive the first guide rail 127 arranged at the third interior sidewall 123 of the first receptacle 121; and a second channel 152 inset along the fourth sidewall 145 of the first enclosure 141, and configured to receive the second guide rail arranged at the fourth interior sidewall 124 of the first receptacle 121. Therefore, when the expansion card 140 is inserted within the expansion slot 120, the first channel 152 and the second channel 152 cooperate with the first guide rail 127 and the second guide rail to maintain the first enclosure 141 within the first receptacle 121.

In the aforementioned example, the latching member 125 of the expansion slot 120 is arranged at a distal end of the first guide rail 127 along the third interior sidewall 123 of the first receptacle 121. Additionally, the first latch receiver 148 of the expansion card 140 is arranged at a distal end of the first channel 152 along the third sidewall 144 of the first enclosure 141. Therefore, when the expansion card 140 is inserted within the expansion slot 120, the first channel 152 guides the first latching member 125 toward the first latch receiver 148 in order to couple the expansion card 140 within the expansion slot 120.

In another implementation as shown in FIG. 2, the latching member 125 includes a first magnetic element 155: arranged at a third interior sidewall 123, normal the first interior sidewall 122, within the first receptacle 121; and defining a first magnetic polarity. Furthermore, the latch receiver 148 can include a second magnetic element 156: arranged at a third sidewall 144, normal the first sidewall 142, of the enclosure 141; defining a second magnetic polarity opposite the first magnetic polarity; and configured to magnetically couple the first magnetic element 155 within the first receptacle 121, and maintain the enclosure 141 within the receptacle 121.

### 9.2 Release Button

In one implementation, the modular computer system 100 includes the first housing 112 of the chassis 110 including a release button 154. The release button 154 is: arranged on the bottom side 115 of the first housing 112; proximal the expansion slot 120; coupled (i.e., mechanically coupled) to the latching member 125 arranged within the receptacle 121; and configured to, in response to actuation of the release button 154, retract the latching member 125 from the latch receiver 148 on the enclosure 141.

In one example, the modular computer system 100 includes a first expansion slot 120 and a second expansion slot arranged at a lateral side of the first housing 112 of the chassis 110. In this example, the modular computer system 100 also includes a first release button 154: arranged at the bottom side 115 of the first housing 112; arranged between the first expansion slot 120 and the second expansion slot; and coupled to a first latching member 125 of the first expansion slot 120 and a second latching member of the second expansion slot. Thus, upon receipt of a force input, such as by a user, the latching member 125 is configured to retract from the latch receiver 148 at the enclosure 141, thereby de-coupling the enclosure 141 from the receptacle 121. As a result, each of the first expansion card 140 and the second expansion card can slide out from the expansion slot 120.

### 9.3 Dual Port Expansion Card

In one implementation, the modular computer system 100 can include an expansion card 140 including: a first external port 151 of a first connector type arranged at the second sidewall 143, opposite the first sidewall 142 of the enclosure 141, and configured to interface with a first external device 156; and a second external port 151 of a second connector type, different from the first connector type, arranged at the second sidewall 143, opposite the first sidewall 142 of the enclosure 141, and configured to interface with a second external device 156.

For example, the modular computer system 100 can include an expansion card 140 including a first external port 151 of a display port type arranged at the second sidewall 143 and configured to receive a display 119 cable. Additionally, the expansion card 140 can include a second external port 151 of a memory port type arranged at the second sidewall 143 and configured to receive a memory card. Therefore, the modular computer system 100 can include a single expansion card 140 with multiple peripheral inputs to connect to the main board 117 within the chassis 110.

### 9.4 Power Expansion Card

In one implementation, the modular computer system 100 can include an expansion card 140 including a power module 157 (e.g., a step-up transformer, a step-down transformer) in order to transform a voltage input to a voltage output to a battery 118 within the chassis 110. In this implementation, the external port 151 is a charging port configured to connect to the battery 118 within the first housing 112; and the expansion card 140 further includes a power module 157. The power module 157 is: arranged within the enclosure 141; and configured to transform a first voltage received at the charging port to a second voltage, different from the first voltage, delivered to the battery 118 within the first housing 112. In one example, the expansion card 140 includes a step-down power module 157 to accommodate for power output of outlets of different regions. In this example, the expansion card 140 can receive an input voltage of 240-volts at the charging port. The power module 157 within the expansion card 140 can thus transform this voltage to 120-volts, and output this voltage at the male connector 150 of the expansion card 140.

### 9.5 Storage Expansion Card

In one implementation, the modular computer system 100 includes an expansion card 140 including a storage module 153 arranged within the second enclosure 141 and configured to interface the main board 117 within the first housing 112 of the chassis no. For example, the storage module 153 can include a 1-terabyte flash memory component within the enclosure 141 of the expansion card 140. Therefore, the modular computer system 100 can receive the expansion card 140 including the storage module 153 in order to connect the storage module 153 to the main board 117 within the chassis 110 and expand memory of the modular computer system 100.

### 9.6 Main Board Integration

In one implementation, the modular computer system 100 can: read a set of electrical signals from the expansion slot 120; detect presence of the expansion card 140 at the expansion slot 120 based on the set of electrical signals; and identify an expansion card 140 type based on the set of electrical signals. The modular computer system 100 can then: generate a notification confirming presence of the expansion card 140 within the expansion slot 120, the notification including the expansion card 140 type for the expansion card 140; and serve the notification to a user via the display 119 at the second housing 116 of the chassis 110.

In one example, a user can mount a memory expansion card 140 including a storage module 153 at an expansion slot 120 of the first housing 112. During a scan cycle, the modular computer system 100 can: read a set of electrical signals from the female connector 126 at the expansion slot 120; detect presence of the expansion card 140 at the expansion slot 120 based on the set of electrical signals; and identify the expansion card 140 as a memory expansion card type based on the set of electrical signals. The modular computer system 100 can then generate a notification including confirmation of presence of the memory expansion card 140 at the expansion slot 120; and transmit this notification to the display 119 for a user operating the modular computer system 100.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A modular computer system comprising:
a chassis comprising:
a first housing comprising a main board; and
a second housing:
pivotably coupled to the first housing; and
comprising a display connected to the main board;
a first expansion slot:
arranged on a first lateral side of the first housing; and
defining a first receptacle inset a bottom side of the first housing; and
comprising:
a first latching member arranged within the first receptacle; and
a first female connector arranged along a first interior sidewall of the first receptacle and connected to the main board; and
a first expansion card comprising:
a first enclosure configured to couple within the first receptacle;
a first latch receiver arranged on the first enclosure, and configured to transiently couple the first latching member within the first receptacle to maintain the first enclosure within the first receptacle;
a first male connector extending from a first sidewall of the first enclosure, and configured to interface the first female connector within the first receptacle of the first expansion slot; and
a first external port arranged at a second sidewall of the enclosure, opposite the first sidewall, and configured to interface with a first external device.

2. The system of claim 1:
wherein the first receptacle defines:
a third interior sidewall normal the first interior sidewall of the first receptacle; and
a fourth interior sidewall opposite the third interior sidewall, and normal the first interior sidewall of the first receptacle;
wherein the first latching member is arranged at the third interior sidewall of the first receptacle;
wherein the first enclosure defines:
a third sidewall arranged normal the first sidewall and second sidewall of the enclosure; and
a fourth sidewall arranged opposite the third sidewall, and normal the first sidewall and second sidewall of the first enclosure; and
wherein the first latch receiver:
is arranged at the third sidewall of the first enclosure; and
defines a first cavity inset the third sidewall of the first enclosure and configured to transiently receive the first latching member arranged at the third interior sidewall of the first receptacle.

3. The system of claim 2:
wherein the first expansion slot further comprises:
a first guide rail arranged along the third interior sidewall of the first receptacle; and
a second guide rail arranged along the fourth interior sidewall, opposite the third interior sidewall, of the first receptacle; and
wherein the first expansion card further comprises:
a first channel inset along the third sidewall of the first enclosure, and configured to receive the first guide rail arranged at the third interior sidewall of the first receptacle; and
a second channel inset along the fourth sidewall of the first enclosure, and configured to receive the second guide rail arranged at the fourth interior sidewall of the first receptacle, the first channel and the second channel cooperating with the first guide rail and the second guide rail to maintain the first enclosure within the first receptacle.

4. The system of claim 3:
wherein the first latching member is arranged at a distal end of the first guide rail along the third interior sidewall of the first receptacle; and
wherein the first latch receiver is arranged at a distal end of the first channel along the third sidewall of the first enclosure, the first channel configured to guide the first latching member toward the first latch receiver.

5. The system of claim 1, further comprising:
a second expansion slot:
arranged on the first lateral side of the first housing;
arranged adjacent the first expansion slot;
defining a second receptacle inset the bottom side of the first housing; and
comprising:
a second latching member arranged within the second receptacle; and
a second female connector arranged along a fifth interior sidewall of the second receptacle and connected to the main board; and
a second expansion card comprising:
a second enclosure configured to couple within the second receptacle;
a second latch receiver arranged on the second enclosure, and configured to transiently couple the second latching member within the second receptacle to maintain the second enclosure within the second receptacle; and
a second male connector extending from a fifth sidewall of the second enclosure, and configured to interface the second female connector within the second receptacle.

6. The system of claim 5, wherein the second expansion card further comprises a storage module arranged within the second enclosure and configured to interface the main board within the first housing of the chassis.

7. The system of claim 1, wherein the first housing of the chassis further comprises a release button:
arranged on the bottom side of the first housing;
arranged proximal the first expansion slot;
coupled to the first latching member arranged within the first receptacle; and
configured to, in response to actuation of the release button, retract the first latching member from the first latch receiver on the first enclosure.

8. The system of claim 1:
wherein the first latching member comprises a first magnetic element:
arranged at a third interior sidewall, normal the first interior sidewall, within the first receptacle; and
defining a first magnetic polarity; and
wherein the first latch receiver comprises a second magnetic element:
arranged at a third sidewall, normal the first sidewall, of the first enclosure;
defining a second magnetic polarity opposite the first magnetic polarity; and
configured to magnetically couple the first magnetic element within the first receptacle, and maintain the first enclosure within the first receptacle.

9. The system of claim 1:
wherein the first receptacle defines:
a third interior sidewall normal the first interior sidewall of the first receptacle; and
a fourth interior sidewall opposite the third interior sidewall, and normal the first interior sidewall of the first receptacle; and
wherein the first enclosure defines:
a third sidewall:
arranged normal the first sidewall and second sidewall of the enclosure; and
abutting with third interior sidewall of the first receptacle;
a fourth sidewall:
arranged opposite the third sidewall, and normal the first sidewall and second sidewall of the first enclosure; and
abutting the fourth interior sidewall of the first receptacle;
the second sidewall set flush with the first lateral side of the first housing; and
a bottom cover:
arranged below the first sidewall, second sidewall, third sidewall and fourth sidewall; and
set flush with the bottom side of the first housing.

10. The system of claim 1, wherein the expansion card further comprises:
the first external port of a first connector type arranged at the second sidewall, opposite the first sidewall of the enclosure, and configured to interface with the first external device; and
a second external port of a second connector type, different from the first connector type, arranged at the second sidewall, opposite the first sidewall of the enclosure, and configured to interface with a second external device.

11. The system of claim 1:
wherein the chassis further comprises a battery arranged within the first housing;
wherein the first external port is a charging port configured to connect to the battery within the first housing; and
wherein the first expansion card further comprises a power module:
arranged within the first enclosure; and
configured to transform a first voltage received at the charging port to a second voltage, different from the first voltage, delivered to the battery within the first housing.

12. The system of claim 1, wherein the first enclosure of the first expansion card comprises:
a first portion arranged within the first receptacle and comprising:
the first sidewall defining a first thickness within the first receptacle; and
the first male connector extending from the first sidewall; and
a second portion:
extending from the first portion of the first enclosure;
proximal the first lateral edge of the first housing;
comprising the second sidewall, opposite the first sidewall, defining a second thickness, greater than the first thickness; and
comprising the external port arranged within the second portion.

13. The system of claim 1, further comprising a second expansion slot:
arranged on a second lateral side, opposite the first lateral side, of the first housing;
defining a second receptacle inset the bottom side of the first housing, the second receptacle configured to receive the first expansion card; and
comprising:
a second latching member arranged within the second receptacle and configured to couple the first latch receiver of the first expansion card; and
a second female connector arranged along a second interior sidewall of the second receptacle and connected to the main board, the second female connector configured to couple the first male connector of the first expansion card.

14. The system of claim 1, wherein the chassis further includes a controller arranged within the first housing, the controller configured to:
read a first set of electrical signals from the first expansion slot;
detect presence of the first expansion card at the first expansion slot based on the first set of electrical signals;
identify an expansion card type based on the first set of electrical signals;
generate a notification confirming presence of the first expansion card within the first expansion slot, the notification including the expansion card type for the first expansion card; and
serve the notification to a user via the display at the second housing of the chassis.

15. A modular computer system comprising:
a chassis arranged in a clamshell configuration;
a set of expansion slots arranged on a first lateral side of the chassis, each expansion slot in the set of expansion slots:
defining a receptacle inset a bottom side of the chassis; and
comprising:
a latching member arranged within the receptacle; and
a female connector arranged along a first interior sidewall of the receptacle;
a set of expansion cards, each expansion card in the set of expansion cards comprising:
an enclosure configured to couple within the receptacle of each expansion slot, in the set of expansion slots;
a latch receiver arranged on the enclosure, and configured to transiently couple the latching member within the receptacle of each expansion slot, in the set of expansion slots, to maintain the enclosure within the receptacle; and
a male connector extending from a first sidewall of the enclosure, and configured to interface the female connector within the receptacle, of each expansion slot, in the set of expansion slots; and
a release button:
arranged on the bottom side of the first housing proximal the set of expansion slots;
coupled to the latching member arranged within the receptacle of each expansion slot, in the set of expansion slots; and
configured to, in response to actuation of the release button, transiently retract latching member from the latch receiver on the enclosure for each expansion card, in the set of expansion cards.

16. The system of claim 15:
wherein the receptacle of each expansion slot, in the set of expansion slots further defines:
a third interior sidewall normal the first interior sidewall of the receptacle; and
a fourth interior sidewall opposite the third interior sidewall, and normal the first interior sidewall of the receptacle;
wherein the latching member of each expansion slot, in the set of expansion slots, is arranged at the third interior sidewall of the receptacle;
wherein the enclosure of each expansion card, in the set of expansion cards defines:
a third sidewall arranged normal the first sidewall and second sidewall of the enclosure; and
a fourth sidewall arranged opposite the third sidewall, and normal the first sidewall and second sidewall of the enclosure; and
wherein the latch receiver of each expansion card, in the set of expansion cards:
is arranged at the third sidewall of the enclosure; and
defines a cavity inset the third sidewall of the enclosure and configured to transiently receive the latching member arranged at the third interior sidewall of the receptacle of each expansion slot, in the set of expansion slots.

17. The system of claim 16:
wherein each expansion slot, in the set of expansion slots, further comprises:
a first guide rail arranged along the third interior sidewall of the receptacle of each expansion slot, in the set of expansion slots; and
a second guide rail arranged along the fourth interior sidewall of the receptacle of each expansion slot, in the set of expansion slots; and
wherein each expansion card, in the set of expansion cards further comprises:
a first channel inset along the third sidewall of the enclosure of each expansion card, in the set of expansion cards, and configured to receive the first guide rail arranged at the third interior sidewall of the receptacle of each expansion slot, in the set of expansion slots; and
a second channel inset along the fourth sidewall of the enclosure of each expansion card, in the set of expansion cards, and configured to receive the second guide rail arranged at the fourth interior sidewall of the receptacle of each expansion slot, in the set of expansion slots, the first channel and the second channel cooperating with the first guide rail and the second guide rail to maintain the enclosure of each expansion card within the receptacle of each expansion slot, in the set of expansion slots.

18. The system of claim 15, wherein each expansion card, in the set of expansion cards, comprises:
an external port arranged at a second sidewall, opposite the first sidewall, of the enclosure, the second sidewall set flush with the first lateral side of the first housing; and
a bottom cover arranged below the first sidewall and the second sidewall of the enclosure, and set flush with the bottom side of the chassis.

19. The system of claim 15:
wherein a first expansion card, in the set of expansion cards, comprises a display port arranged at a second sidewall, opposite the first sidewall, of a first enclosure for the first expansion card;
wherein a second expansion card, in the set of expansion cards, comprises:
a charging port arranged at a second enclosure for the second expansion card; and
a power module arranged within a second enclosure of the second expansion card, and configured to transform a first voltage received at the charging port to a second voltage, different from the first voltage; and
wherein a third expansion card, in the set of expansion cards, comprises a storage module arranged within a third enclosure of the third expansion card and configured to interface the main board within the chassis.

20. A modular computer system comprising:
a chassis comprising a main board;
a first expansion slot:
arranged on a first lateral side of the first housing; and
defining a first receptacle inset a bottom side of the first housing; and
comprising a first female connector arranged along a first interior sidewall of the first receptacle and connected to the main board; and
a first expansion card comprising:
a first enclosure configured to couple within the first receptacle, the first enclosure set flush with the first lateral side and the bottom side of the first housing;
a first male connector extending from a first sidewall of the first enclosure, and configured to interface the first female connector within the first receptacle of the first expansion slot; and
a first external port arranged at a second sidewall of the enclosure, opposite the first sidewall, and configured to interface with a first external device.
